(19) United States
(12) Patent Application Publication
(10) Pub. No.: US 2016/0169182 A1
(43) Pub. Date: Jun. 16, 2016

(54) INTEGRATED HIGH PRESSURE PUMP WITH CYLINDER BLOCK

(71) Applicants: Hyundai Motor Europe Technical Center GmbH, Russelsheim (DE); Hyundai Motor Company, Seoul (KR); Kia Motors Corp., Seoul (KR)

(72) Inventors: Stephan FITZNER, Echzell (DE); Ulrich KARRER, Mainz (DE)

(73) Assignees: Hyundai Motor Europe Technical Center GmbH, Russelsheim (DE); Hyundai Motor Company, Seoul (KR); Kia Motors Corp., Seoul (KR)

(21) Appl. No.: 14/744,666

(22) Filed: Jun. 19, 2015

(30) Foreign Application Priority Data
Dec. 16, 2014 (KR) 10-2014-0181812

(51) Int. Cl. F02M 63/02

(52) U.S. Cl. CPC F02M 63/0265

(57) ABSTRACT

An integrated high pressure pump with a cylinder block may include the cylinder block having a crank shaft positioned therein and a pump hole having a predetermined diameter formed in a direction perpendicular to a length direction of the crank shaft, and a tappet guide part seated to be inserted along the pump hole to connect the cylinder block and a high pressure pump device to each other, in which the high pressure pump device is provided with a tappet moved along an inner portion of the tappet guide part, such that turning force of the crank shaft is directly transferred thereto.

### CROSS REFERENCE TO RELATED APPLICATION

The present application claims priority to Korean Patent Application No. 10-2014-0181812, filed Dec. 16, 2014, the entire contents of which is incorporated herein for all purposes by this reference.

### BACKGROUND OF THE INVENTION

1. Field of the Invention

The present invention relates to an integrated high pressure pump with a cylinder block, and more particularly, to a technology capable of solving a difficult in designing a cylinder block itself due to a bearing and a chain belt that are required to install a high pressure pump according to the related art and a weight problem due to devices around the high pressure pump by using the high pressure pump that is directly connected to a crank shaft.

2. Description of Related Art

Since a direct injection engine is generally configured to directly inject fuel into a combustion chamber at high pressure, the fuel to be supplied into the combustion chamber needs to be subjected to high pressurization. A fuel supplying system according to the related art for forming fuel pressure of high pressure includes a low pressure pump that pumps the fuel from a fuel tank at relatively low pressure and a high pressure pump that pumps the fuel at high pressure by re-pressurizing the fuel supplied from the low pressure pump.

Meanwhile, the high pressure pump is typically configured so as to be driven by drawing power from a cam shaft of the engine, or the like and is seated on an inner side of a chain housing in the cylinder block as shown in FIG. 1.

As shown in FIG. 1, the high pressure pump 10 according to the related art is positioned in a cylinder block 30, and particularly, is formed on one side of a chain housing 20 in which a chain belt 40 moved by turning force of an engine is formed.

Meanwhile, although not shown in FIG. 1, the high pressure pump 10 has a rotation shaft provided therein, wherein the rotation shaft has a bearing interposed on an outer peripheral surface thereof

A so-called plain bearing has been used for the outer peripheral surface of the rotation shaft so that the high pressure pump 10 itself may be positioned in the cylinder block 30 and high turning force may be transferred to the high pressure pump 10.

However, since the high pressure pump in which the plain bearing formed on the outer peripheral surface of the rotation shaft is installed is positioned in the cylinder block 30 as described above, high strength of friction and load has been applied to the high pressure pump.

In addition, since the high pressure pump 10 is fixed to the chain housing 20 through a flange and the chain housing 20 in which the chain belt 40 is moved and a high pressure pump housing having the high pressure pump 10 provided therein are separately required, weight may be increased due to two housings. In the case in which the high pressure pump 10 is failure, when the failed high pressure pump 10 is replaced with a new high pressure pump, joint performance with the chain housing 20 may be deteriorated.

Therefore, various aspects of the present invention are directed to providing an integrated high pressure pump with a cylinder block 30 capable of making an effect of reducing friction force and weight due to a decrease of the plain bearing and the chain belt that were conventionally used by improving a position of the high pressure pump positioned in the cylinder block 30 according to the related art and also reducing production costs by reducing unnecessary components.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an integrated high pressure pump with a cylinder block having a new structure capable of reducing friction force, costs, weight, and the like as compared to the related art by improving a structure in which turning force of a crank shaft is indirectly transferred to the high pressure pump through a chain belt.

According to various aspects of the present invention, an integrated high pressure pump with a cylinder block may include the cylinder block having a crank shaft positioned therein and a pump hole having a predetermined diameter formed in a direction perpendicular to a length direction of the crank shaft, and a tappet guide part seated to be inserted along the pump hole and connecting the cylinder block and a high pressure pump device to each other, in which the high pressure pump device is provided with a tappet moved along an inner portion of the tappet guide part, such that turning force of the crank shaft is directly transferred thereto.

The crank shaft may include a cam installed at one point on an outer peripheral surface thereof, and the tappet may be in contact with an outer peripheral surface of the cam and moveable back and forth by a turn of the crank shaft.

The tappet guide part may include a vertical flange extending a predetermined length in a direction of the cam and having a guide hole formed therein, the tappet being moveable through the guide hole, and a horizontal flange extending from the vertical flange and coupled to an outer portion of the cylinder block through a bolt.

The high pressure pump device may be coupled to the horizontal flange through the bolt, and may have the tappet formed therein, the tappet being moved along the guide hole formed in the vertical flange, and an inlet valve formed therein, in which the inlet valve may supply fuel into the high pressure pump device and may be opened and closed by a separate control unit.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an overall configuration view in which a high pressure pump according to the related art is installed.

FIG. 2 is an overall perspective view of an exemplary integrated high pressure pump with a cylinder block according to the present invention, which is coupled to the cylinder block.

FIG. 3 is a cross-sectional view of the exemplary high pressure pump according to the present invention, which is coupled to the cylinder block.

FIG. 4 is an exploded perspective view of the exemplary high pressure pump with the cylinder block according to the present invention.

FIG. 5 is a schematic view for describing an operation process of an exemplary high pressure pump device according to the present invention.

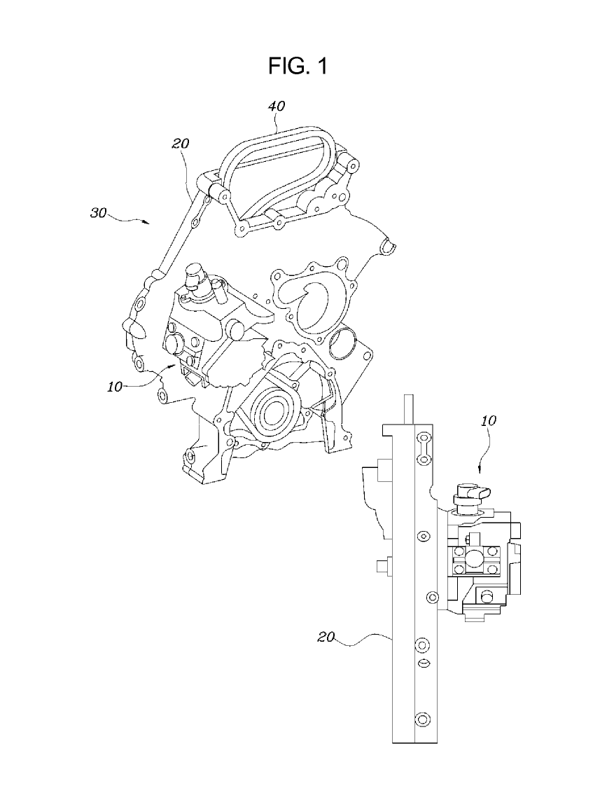

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

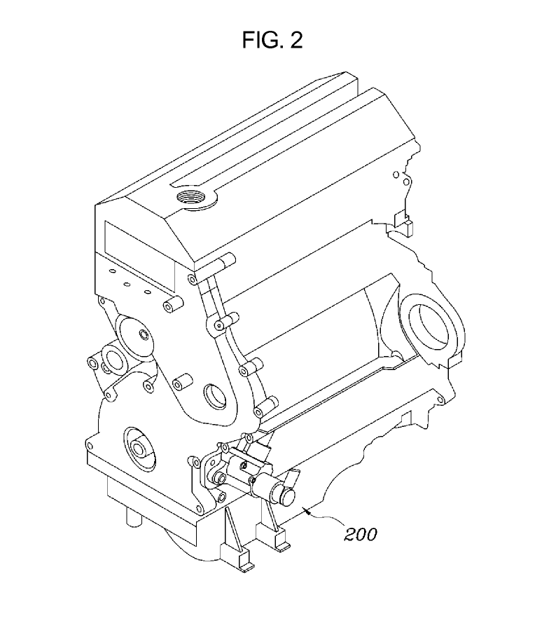

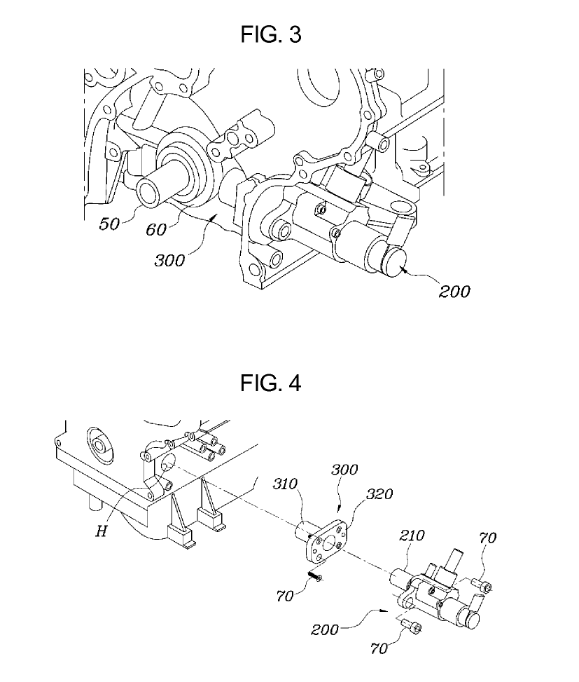

FIG. 2 is an overall perspective view of an integrated high pressure 200 with a cylinder block 100 according to an exemplary embodiment of the present invention, which is coupled to the cylinder block 100, FIG. 3 is a cross-sectional view of the high pressure pump 200 according to an exemplary embodiment of the present invention, which is coupled to the cylinder block 100, and FIG. 4 is an exploded perspective view of the present invention.

The present invention relates to a technology allowing turning force of a crank shaft positioned in a cylinder block 100 to be directly transferred to a high pressure pump 200 by changing a position at which the high pressure pump is conventionally coupled to one side of a chain housing.

To this end, the present invention includes a cylinder block 100 having a crank shaft 50 positioned therein and having a pump hole H having a predetermined diameter formed in a direction which is perpendicular to a length direction of the crank shaft 50 and a tappet guide part 300 seated to be inserted along the pump hole H so as to connect the cylinder block 100 and a high pressure pump device 200 to each other, wherein the high pressure pump device 200 is provided with a tappet 210 which is moved along an inner portion of the tappet guide part 300 such that turning force of the crank shaft 50 is directly transferred thereto.

That is, as shown in FIG. 3 and FIG. 4, the crank shaft 50, which is a configuration according to the related art, is provided in the cylinder block 100, and a pump hole H having a predetermined diameter is formed in one side of the cylinder block 100 in a direction which is perpendicular to a length direction of the crank shaft 50.

According to the related art, the high pressure pump is coupled to one side of the chain housing. However, according to an exemplary embodiment of the present invention, the high pressure pump is not installed on one side of the chain housing, the pump hole H having the predetermined diameter is formed in one side of the cylinder block 100, and the high pressure pump is installed on an outer portion of the cylinder block 100 through the tappet guide part 300 to be described below along the pump hole H.

Due to the change of the position of the high pressure pump as described above, since the number of bearings used when the high pressure pump and the conventionally used chain housing are coupled to each other may be reduced, the chain housing having excellent stiffness for supporting the high pressure pump may not be required, and a size of the chain housing may also be reduced, various effects such as a decrease in a total of weight, and the like may be implemented.

Meanwhile, referring to again FIG. 3 and FIG. 4, the tappet guide part 300 that is seated to be inserted in a direction of the pump hole H so as to connect the cylinder block 100 and the high pressure pump device to each other is shown.

The tappet guide part 300 has an aspect performing a function connecting the crank shaft 50 and the high pressure pump to each other so that the turning force of the crank shaft 50 may be directly transferred to the high pressure pump, but is also a structure capable of using the present invention without significantly changing a production line of the cylinder block 100 or an engine block.

That is, the tappet guide part 300 performs a function of a kind of supporting part so that the high pressure pump may be fixed on an outer portion of the cylinder block 100 to allow the turning force of the crank shaft 50 positioned in the cylinder block 100 to be directly transferred to the high pressure pump and also performs a function of reducing friction force, which allows the friction force by a turn of the crank shaft 50 not to be directly transferred to the high pressure pump.

Meanwhile, the high pressure pump device 200 is provided with a tappet 210 which is moved along an inner portion of the tappet guide part 300, such that the turning force of the crank shaft 50 is directly transferred thereto.

The tappet 210 performs a function that pushes up a valve as known in the art, and particularly, performs an action that transfers a motion of a cam moved together with the crank shaft to the value so as to open and close a valve for intake and exhaust in an internal combustion engine.

Hereinafter, although being specifically described, the tappet 210 which may be moved in back and forth according to the turn of the crank shaft is provided in the high pressure pump device 200, and inflow and discharge processes of fuel are performed in the high pressure pump according to the movement of the tappet 210.

Meanwhile, as shown, a cam 60 is installed at one point on an outer peripheral surface of the crank shaft, wherein an end point of the tappet 210 is in contact with one point on an outer peripheral surface of the cam 60, such that the tappet 210 is moved back and forth while the cam 60 is also linked with the crank shaft 50 to be turned when the crank shaft 50 is turned.

That is, as known in the art, since the cam 60 is configured to have an elliptical shape, the tappet 210 is moved back and forth according to the turn of the cam 60.

According to an exemplary embodiment of the present invention, as described above, the turning force of the crank shaft 50 is directly transferred to the high pressure pump by the tappet 210 that is directly in contact with the cam 60 coupled to the outer peripheral surface of the crank shaft 50.

Meanwhile, the tappet guide part 300 includes a vertical flange 310 extended by a predetermined length in a direction of the cam 60 and having a guide hole formed therein, with the tappet 210 may be moved through the guide hole, and a horizontal flange 320 extended from the vertical flange 310 and coupled to the outer portion of the cylinder block through a bolt 70.

That is, the vertical flange 310 has the guide hole having the predetermined length provided therein so that the tappet 210 may be moved and the horizontal flange 320 is extended from the vertical flange 310, wherein one side of the horizontal flange 320 is coupled to an outer one point of the cylinder block 100 through the bolt 70 and the other side of the horizontal flange 320 is also fastened to the high pressure pump device 200 through the bolt 70.

In addition, the high pressure pump device 200 has the tappet 210 formed therein, with the tappet 210 being moved along the guide hole formed in the vertical flange 310 as described above, and an inlet valve 80 formed therein, in which the inlet valve 80 supplies the fuel into the high pressure pump device 200, and is opened and closed by a separate control unit 400.

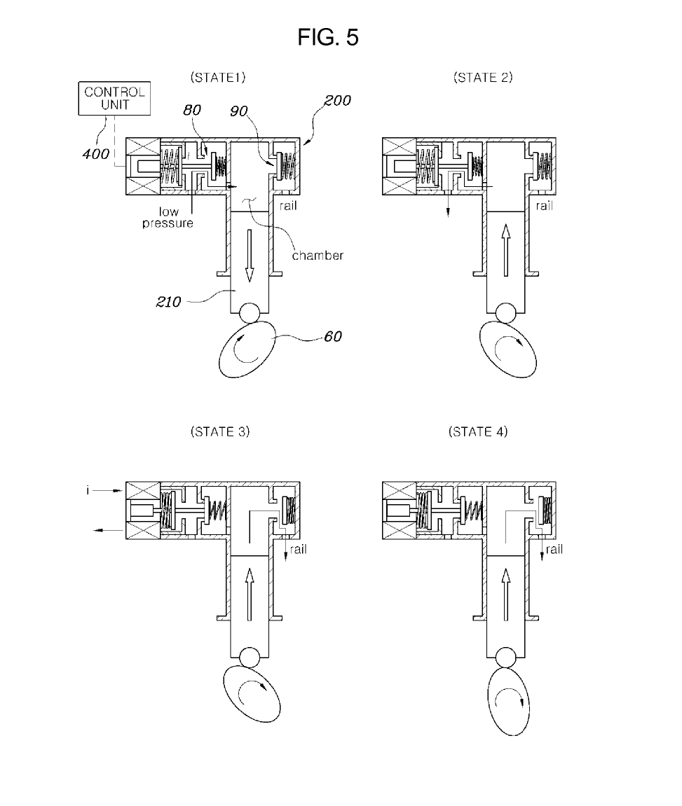

That is, FIG. 5 is a schematic configuration view of the high pressure pump device 200 according to an exemplary embodiment of the present invention. As shown in FIG. 5, the high pressure pump device 200 is provided with the inlet valve 80 and an outlet valve 90. In a state 1, the inlet valve 80 is opened, such that low pressure fuel supplied from a low pressure pump is introduced into a chamber by a decent of the tappet 210, in a state 2, the tappet 210 starts to be ascended, in a state 3, fuel in the chamber is pressurized by closing the inlet valve 80 by an electronic control, such that the outlet valve 90 is opened and high pressure fuel starts to be supplied into a fuel rail, and in a state 4, the supply of the high pressure fuel reaches a maximum point. Then, a series of operations in which the state is switched into the state 1 again by the turn of the cam shaft are performed.

However, FIG. 5 is a schematic configuration view for describing operation processes of the high pressure pump device 200 according to an exemplary embodiment of the present invention, and since the operation processes of the high pressure pump are the well-known technology, a description thereof will be omitted.

According to various embodiments of the present invention, the integrated high pressure pump with the cylinder block may implement various effects that friction force, costs, weight, and the like may be reduced, the chain housing may also be reduced as compared to the related art, and the like.

Although the present invention is shown and described in connection with the specific embodiments, it is apparent to those skilled in the art that the modifications and variations can be made without departing from the spirit and scope of the invention as defined by the appended claims

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An integrated high pressure pump with a cylinder block, the integrated high pressure pump comprising:
the cylinder block including a crank shaft positioned therein and a pump hole having a predetermined diameter formed in a direction perpendicular to a length direction of the crank shaft; and
a tappet guide part seated to be inserted along the pump hole and connecting the cylinder block and a high pressure pump device to each other,
wherein the high pressure pump device is provided with a tappet movable along an inner portion of the tappet guide part, such that turning force of the crank shaft is directly transferred thereto.

2. The integrated high pressure pump of claim 1, wherein the crank shaft includes a cam installed at one point on an outer peripheral surface thereof, and
the tappet is in contact with an outer peripheral surface of the cam and moveable back and forth by a turn of the crank shaft.

3. The integrated high pressure pump of claim 2, wherein the tappet guide part includes a vertical flange extending a predetermined length in a direction of the cam and having a guide hole formed therein, the tappet being moveable through the guide hole, and a horizontal flange extending from the vertical flange and coupled to an outer portion of the cylinder block through a bolt.

4. The integrated high pressure pump of claim 3, wherein the high pressure pump device is coupled to the horizontal flange through the bolt, and has the tappet formed therein, the tappet being moved along the guide hole formed in the vertical flange, and an inlet valve formed therein, wherein the inlet valve supplies fuel into the high pressure pump device and is opened and closed by a separate controller.
